(19) United States
(12) Patent Application Publication
(10) Pub. No.: US 2005/0288982 A1
(43) Pub. Date: Dec. 29, 2005

(54) Configuration system for solution business and composition method for that

(76) Inventors: Hiroyuki Konno, Yokohama (JP); Kenichi Funaki, Tokyo (JP); Yasunori Yamashita, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/165,221

(22) Filed: Jun. 24, 2005

(30) Foreign Application Priority Data
Jun. 28, 2004 (JP) 2004-189284

(51) Int. Cl. G06F 17/60

(52) U.S. Cl. 705/7; 705/8

(57) ABSTRACT

A configuration system that composes a configuration for solution business in accordance with restrictions on availability to combine between items, and facilitates maintenance of the configuration when the number of items is increased. An item registration unit registers specifications and the like for each item in a database. An item interface registration unit and an item interface setting unit register interface information between items in the database. A solution composition search unit, responsive to a particular item name specified, searches the database to sequentially retrieve interface information of associated items one after another through associated interface information and operating conditions, and totally composes items to be connected to the specified item, and connectable items into a configuration.

### INCORPORATION BY REFERENCE

The present application claims priority from Japanese application JP 2004-189284 filed on Jun. 28, 2004, the content of which is hereby incorporated by reference into this application.

### BACKGROUND OF THE INVENTION

The present invention relates to a configuration system for solution business which is directed to determine items that make up a solution.

For providing a solution desired by a client as early as possible, it is important to provide a combination of items which include existing articles, techniques, and services. However, when items are combined for proposing a solution, it is necessary to take into consideration restrictions on availability to combine between computer equipment and software. In this event, for a solution business which should realize wishes of a client in a timely manner, techniques are desired for simply realizing the restrictions on availability to combine between computer equipment and software even if an immense number of items are to be combined for providing a solution, in consideration of the fact that a larger number of items to be treated is more advantageous.

Conventionally, restrictions on availability to a combination among items have been realized by a method of setting a constraint program which determines whether or not a combination is available when attribute values of items meet certain conditions (see, for example, JP-A-2003-162546), or by a score sheet-based method which describes all items in a matrix table, and marks “O” in a cell at which a row of an available item intersects with a column of another available item (see, for example, JP-A-2001-22764).

The method described in JP-A-2003-162546 cited above can freely describe restriction conditions through programming and therefore set the conditions in detail. Disadvantageously, however, this method requires an expert skilled in programming in order to implement the method.

The method described in JP-A-2003-162546 in turn employs a score sheet to mark “O” for items available for combination, and can therefore permit the user to readily set restriction conditions. However, this method has a problem of a long time required to maintain the score sheet when a large number of items must be managed by the score sheet or when a new item is added to the score sheet.

### SUMMARY OF THE INVENTION

It is an object of the present invention to handle restrictions on availability to combine items to solve the foregoing problems to compose a configuration for solution business.

In the following, any of articles, products, and parts of hardware and software is called an “item,” and any of an item which interposes between a hardware item and a software item to couple the two items for operation, a combination which couples a hardware item and a software item for operation, and communication specifications between a software item and a hardware item is collectively called an “interface.”

The present invention provides a configuration system for solution business which includes an item interface table for storing interface information corresponding to the item name of each item, and an operating condition table for storing the name of another item which is essential for operating the item, in correspondence to the item name as an operating condition. When a particular item name is specified, the system sequentially retrieves interface information of associated items one after another through associated interface information and operating conditions, and totally composes items to be connected to the specified item, and connectable items into a configuration.

The configuration system for solution business according to the present invention does not require programming, and facilitates maintenance of the configuration when the number of items is increased.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a system configuration according to one embodiment of the present invention;

FIG. 2 is a block diagram illustrating a hardware configuration according to one embodiment of the present invention;

FIG. 3 is a diagram illustrating communications in time series between respective components of a system and a database in one embodiment;

FIG. 4 is a diagram illustrating an example of an interface registration screen;

FIG. 5 is a diagram showing an example of an interface table;

FIG. 6 is a diagram illustrating an example of an item category registration screen;

FIGS. 7A and 7B are diagrams showing an application/function table and a specification item table, respectively;

FIG. 8 is a diagram illustrating an example of an item registration screen;

FIG. 9 is a diagram illustrating an example of an item interface setting screen;

FIGS. 10A to 10C are diagrams showing examples of an item table, a specification table, and an item interface table, respectively;

FIG. 11 is a diagram illustrating an example of an operating condition setting screen;

FIG. 12 is a diagram illustrating an example of an operating condition addition screen;

FIG. 13 is a diagram showing an example of an operating condition table;

FIG. 14 is a diagram illustrating an example of a solution search screen;

FIG. 15 is a flow chart illustrating a processing procedure for a solution search in one embodiment of the present invention;

FIG. 16 is a diagram showing an example of a search result storage table;

FIG. 17 is a diagram illustrating an example of a solution search result display screen;

FIG. 18 is a flow chart illustrating a procedure for an associated item extraction process;

FIGS. 19A-19E are diagrams each showing an example of an associated item storage table;

FIG. 20 is a diagram showing an example of a configuration table; and

FIG. 21 is a diagram illustrating an example of a solution configuration screen.

### DESCRIPTION OF THE EMBODIMENTS

In the following, an embodiment of a configuration system for solution business according to one embodiment of the present invention will be described with reference to the accompanying drawings.

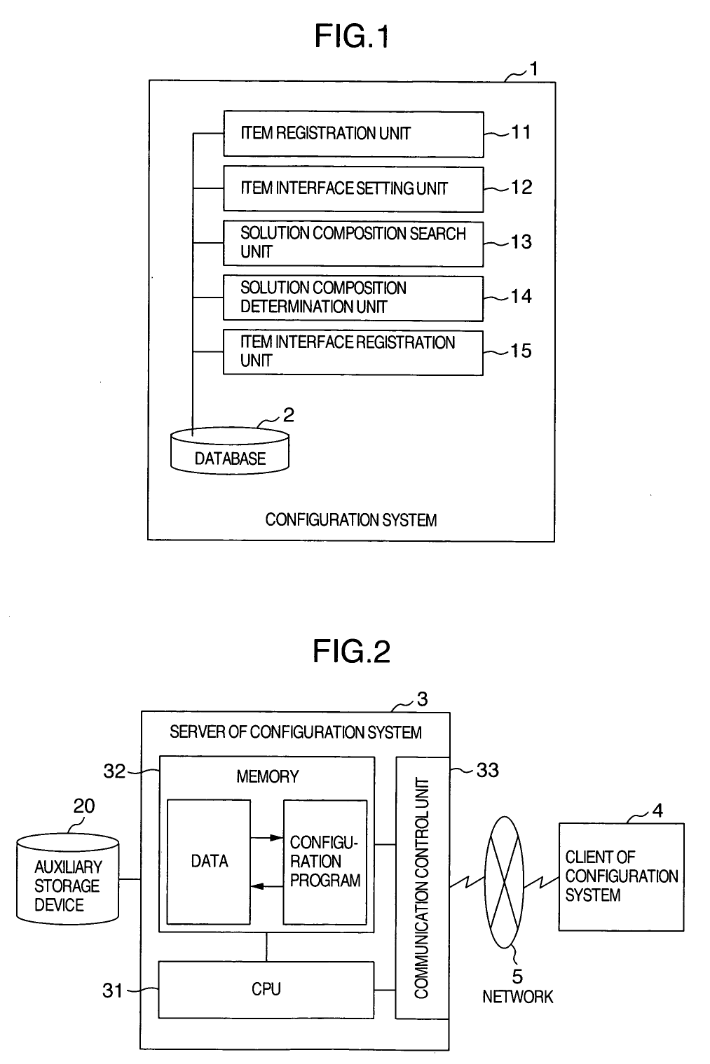

First, a description will be given of the general configuration of the configuration system for solution business according to the present invention. FIG. 1 is a block diagram illustrating one embodiment of an information processing system which embodies the configuration system for solution business according to the present invention.

As illustrated in FIG. 1, the configuration system 1 for solution business comprises an item interface registration unit 15, an item registration unit 11, an item interface setting unit 12, a solution composition search unit 13, a solution composition determination unit 14, and a database 2.

The item interface registration unit 15 executes a process of registering the database 2 with features of an interface which intervenes between items. Here, the items refer to articles, products or parts of hardware and software which can be components of a solution. When both items are hardware items, the interface is an item which intervenes between the two items to couples the two items for operation. When two items are software items, the interface comprises communication specifications between the two items. When one item is a hardware item and the other item is a software item, the interface comprises information indicating that there is a combination of items which are coupled for operation, for example, an interface between a personal computer (PC) and an operating system (OS).

The item registration unit 11 classifies respective items according to categories, registers the database 2 with functions, applications, specification items, and specification units on a category-by-category basis, and registers the database 2 with a price, a specification value, and operating conditions for each item. The item interface setting unit 12 sets an interface possessed by an item. The solution composition search unit 13 searches for an item composition required to implement a solution using a key which may be a problem to be solved, a function or an application to be implemented, and presents the retrieved item composition to the user. The solution composition determination unit 14 sets necessary items and their quantities from the retrieved item composition. The database 2 holds data on results registered or set by the respective components in a storage device.

Next, a description will be given of the hardware configuration of the configuration system for solution business. FIG. 2 illustrates the hardware configuration of the configuration system 1 for solution business in one embodiment.

The configuration system 1 for solution business runs on a computer which is shown as a server 3 for the configuration system for solution business. The computer shown as the server 3 for the configuration system for solution business comprises a CPU 31, a memory 32, a communication control unit 33, and an auxiliary storage device 20. The respective components described in connection with FIG. 1 are stored in the auxiliary storage device 20 in the form of a configuration program which is read into the memory 32 as required, and executed by the CPU 31. The database 2 described in connection with FIG. 1 is stored in the auxiliary storage device 20, for example, as a relational database or a file, and is referenced and updated by the configuration program.

Also, a computer which is shown as a client 4 of the configuration system for solution business creates data required by the server 3 of the configuration system for solution business, and transmits the data to the server 3 through a network 5. The server 3 registers received data in the auxiliary storage device 20. The client 4 comprises an input device and a display device for displaying screens shown below.

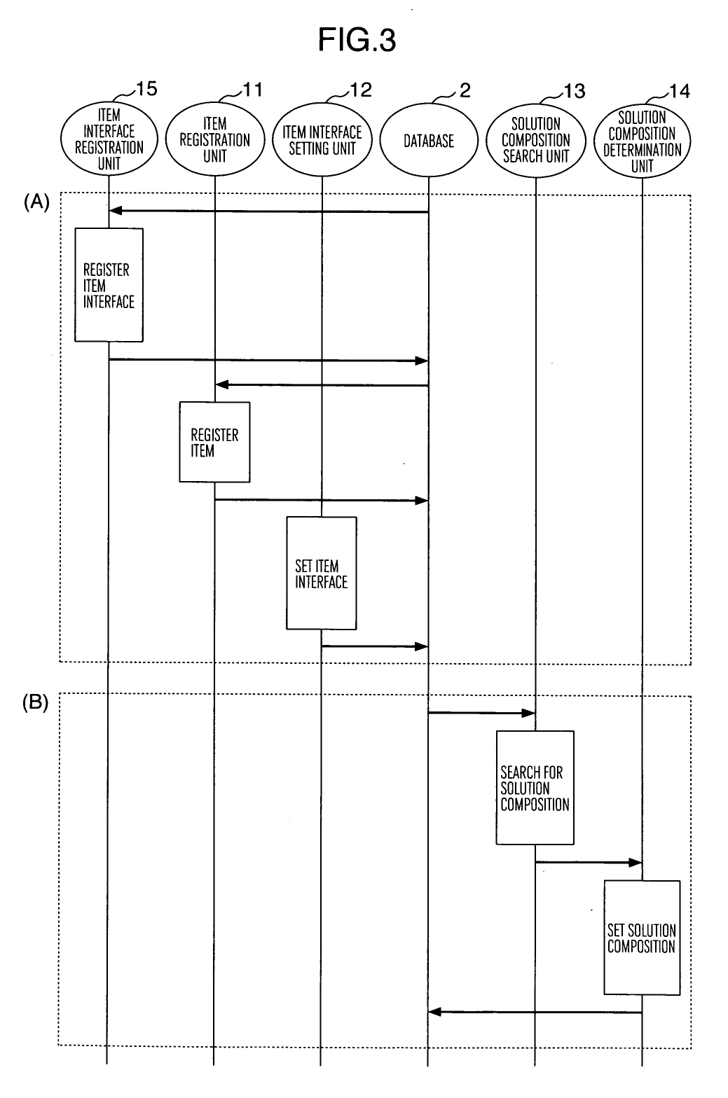

FIG. 3 is a diagram illustrating communications in time series between the respective components of the configuration system for solution business and the database 2, described in connection with FIG. 1. First described is a procedure for a process of preparing data required by the server 3 of the configuration system for solution business illustrated in FIG. 3(A). The item interface registration unit 15 registers the database 2 with features of an interface which intervenes between items.

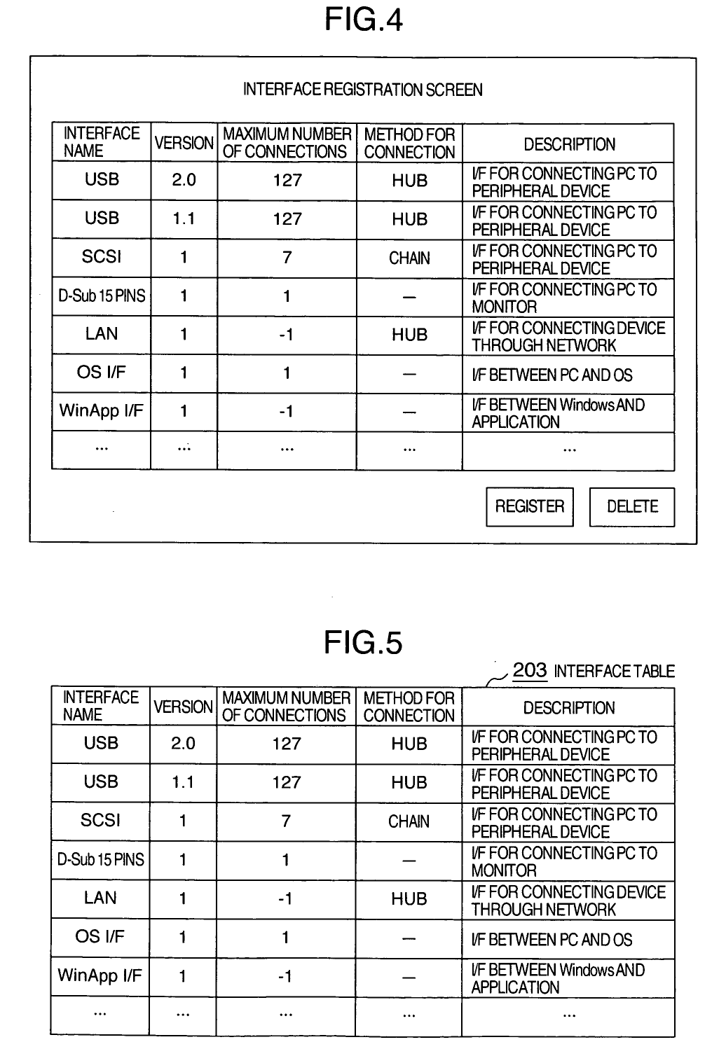

FIG. 4 is a diagram illustrating an example of an interface registration screen displayed by the item interface registration unit 15 to register features of a displayed interface. This registration screen displays contents of records registered in an interface table 203, later described. In an initial state, each field is blank. A person in charge enters, for each type of interface, an interface name, a version of a standard associated with an interface, a maximum number of items available for connection to the interface, a method for connection when the maximum number of available connections is two or more, and description on the interface.

Entered contents may be not only physical interfaces, for example, USB for connecting the PC to a peripheral devices, and the like, but also logical interfaces (example: Windows Application Interface) for connecting the OS to an application. Also, since there are an infinite number of applications which can be connected to the OS, the maximum number of connections in this case is represented by “−1” in this embodiment. Also, a hub in the method for connection means a single interface which can simultaneously connect a plurality of items. A chain means an interface which can connect items from one to another in a chain arrangement.

After the person in charge has depressed a REGISTER button on the screen, the item interface registration unit 15 registers the entered data in the interface table 203 within the database 2. FIG. 5 shows an example of the interface table 203. Items in the interface table 203 are the same as the items registered on the interface registration screen of FIG. 4, wherein each record is composed of an interface name, a version, a maximum number of available connections, a method for connection, and a description. It should be noted that the items are named such that a record can be uniquely identified from the interface name and version fields.

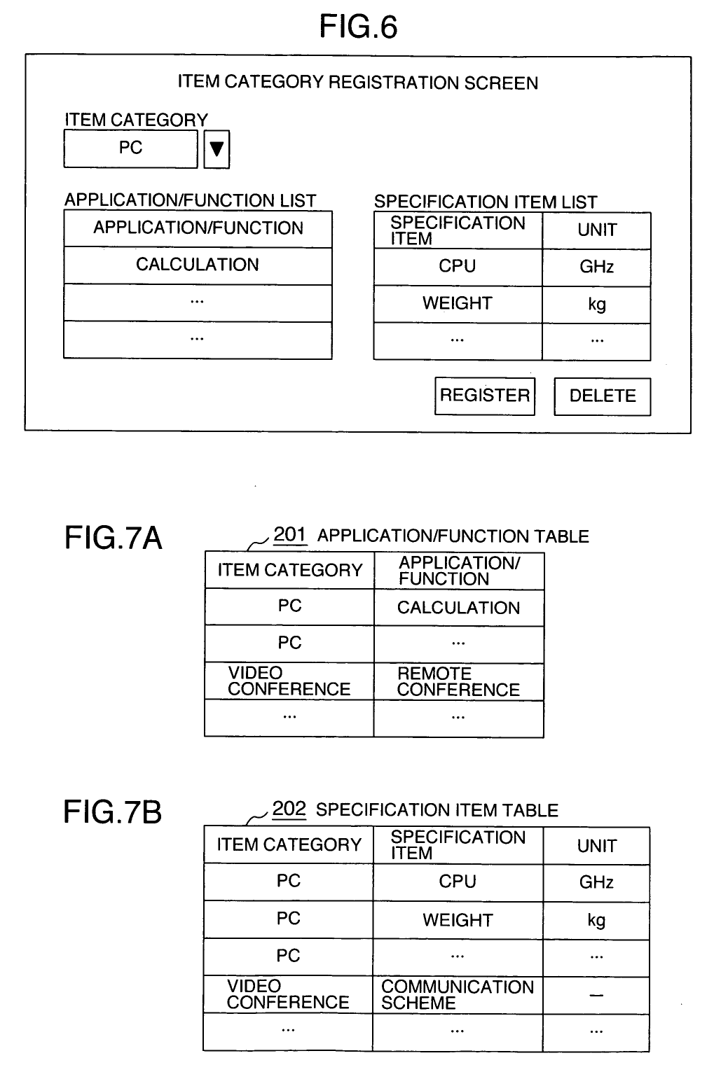

The item registration unit 11 in FIG. 3 creates item categories for classifying items, sets the item categories to which respective items belong, and registers the database 2 with specifications of the items. FIG. 6 is a diagram illustrating an example of an item category registration screen for registering an item category. The person in charge enters, for each item category, items named “application/function” which is used as a search keyword when a problem is to be solved, specification items which represent features of an item which belongs to the item category, and an item named “unit” through this screen. For items belonging to the same item category, a consistent standard catalog specification table can be created only by registering corresponding values in accordance with the specification items registered on this screen. Also, since features other than specifications can be registered in plain text in the application/function list, an item can be searched for with keys which indicate features of the item that are not listed on a specification table of a catalog by a solution search process, later described.

As the person in charge depresses a REGISTER button on the screen, the item registration unit 11 registers the entered items in an application/function table 201 and a specification item table 202 within the database 2. FIGS. 7A and 7B show the application/function table 201 and specification item table 202, respectively. The application/function table 201 in FIG. 7A is a table for storing data entered in the “application/function list” on the item category registration screen, and stores records related to applications and functions for each item category. Since the application/function is not set for each item but for each item category, a small amount of data is only required therefor. It should be noted that a record can be uniquely identified by the fields of the item category and application/function. The specification item table 202 in FIG. 7B, in turn, is a table for storing data entered in the “specification item list” on the item category registration screen, and stores records about specification items and units associated therewith for each item category. It should be noted that a record can be uniquely identified by the fields of the item category and specification item.

The item registration unit 11 also puts together the fields of the item category on the application/function table 201 into one menu having item category options, which is displayed as an item category menu on this screen. In response to a selection of an item category from this menu made by the person in charge, the item registration unit 11 extracts at least one record which matches the item category, selected from the item category fields of the application/function table 201, and displays the values of the application/function fields in these records in the “application/function list.” Together with this, the item registration unit 11 extracts records which match the item category, selected from the item category fields of the specification item table 202, and displays the values of the specification item fields and unit fields in the “specification item list.” In this way, the person in charge can confirm previously entered data.

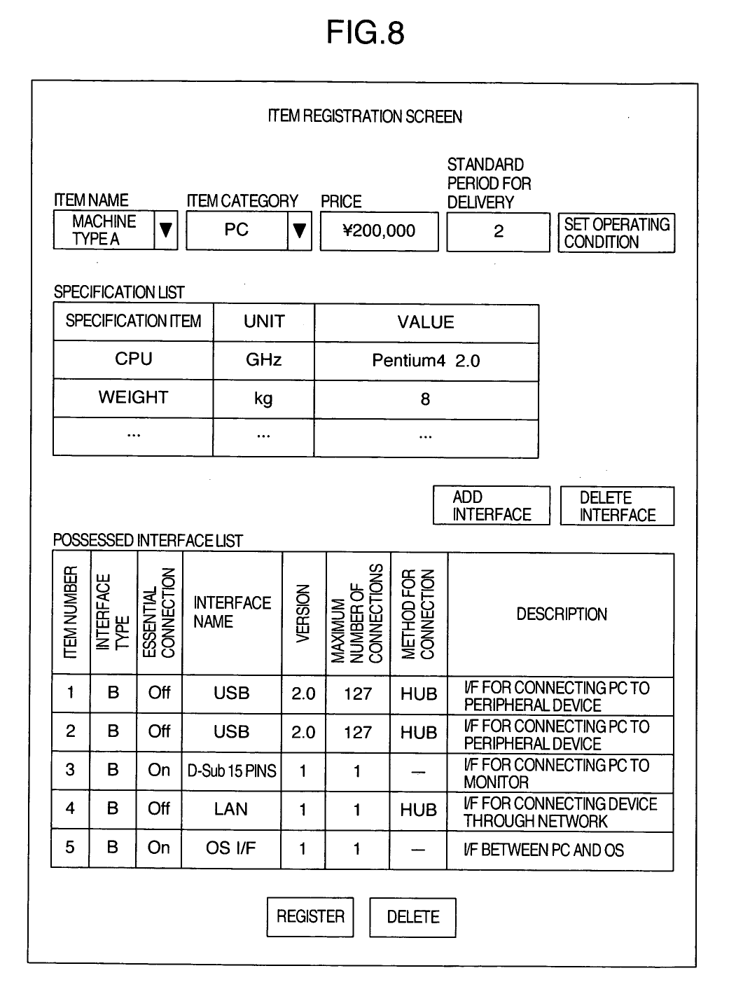

FIG. 8 is a diagram illustrating an example of an item registration screen for registering the name of an item, an item category to which the item belongs, specifications of the item, a possessed interface, and the like. The person in charge enters for each item, the name, an item category to which the item belongs, the price, and a standard period for delivery through this screen. Here, the item registration unit 11 puts together the fields of the item category on the specification item table 202 into one menu having item category options, which is displayed as an item category menu on the screen. As the person in charge selects an item category from this menu, the item registration unit 11 extracts at least one record which matches the item category, selected from the item category fields in the specification item table 202, and displays the values of the specification item fields and unit fields of these records in a “specification list.” The person in charge may enter specification values corresponding to the fields of the “value” in the “specification list” with reference to a product catalog and the like.

Items displayed in a “possessed interface list” comprise an item number for uniquely identifying an interface, an interface type indicative of the type (A: male, B: female) of a socket of the interface, an essential connection, the name of the interface, a version of the interface, a maximum number of items which can be connected simultaneously, a method for connection, and a description on the interface. The item “essential connection” includes a flag which indicates whether or not the associated interface must be necessarily utilized. For example, the first row in the list indicates that a USB 2.0 interface of type B having an item number 1 can be combined with items (127 items at maximum) having an interface of type A (male) before USB version 2.0.

The item registration unit 11 displays records which have the same values as those in item name fields of an item interface table 206, later described. A field “maximum number of connection” and a field “method for connection” contain data which have been retrieved by searching the interface table 203 using “interface name” and “version” as keys. In an initial state, each field in the item interface table 206 is blank.

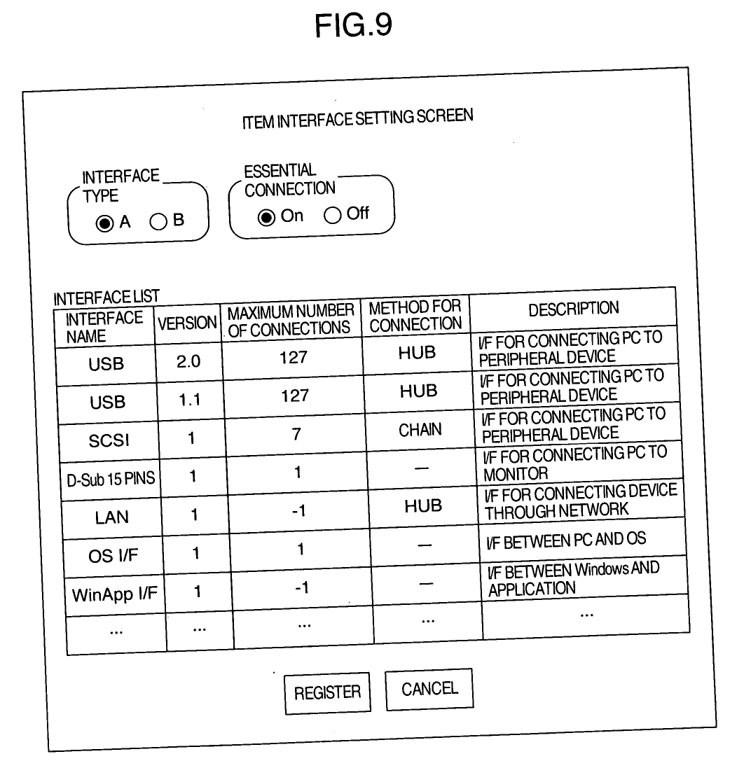

For adding a possessed interface of an item, the person in charge may depress an ADD INTERFACE button on the item registration screen to allow the addition. The item interface setting unit 12 displays an item interface setting screen illustrated in FIG. 9 in response to a depression on the ADD INTERFACE button. The item interface setting unit 12 displays all records stored in the interface table 203 on an “interface list” on this screen. As the person in charge selects an interface which he wishes to add, selects options of the interface type and essential connection, and depresses a REGISTER button, the item interface setting unit 12 adds the data on the interface to the “possessed interface list” shown in FIG. 8. When there are a plurality of possessed interfaces to be added, the person in charge can depress the ADD INTERFACE button for each of the interfaces to add data on each interface from one interface to another.

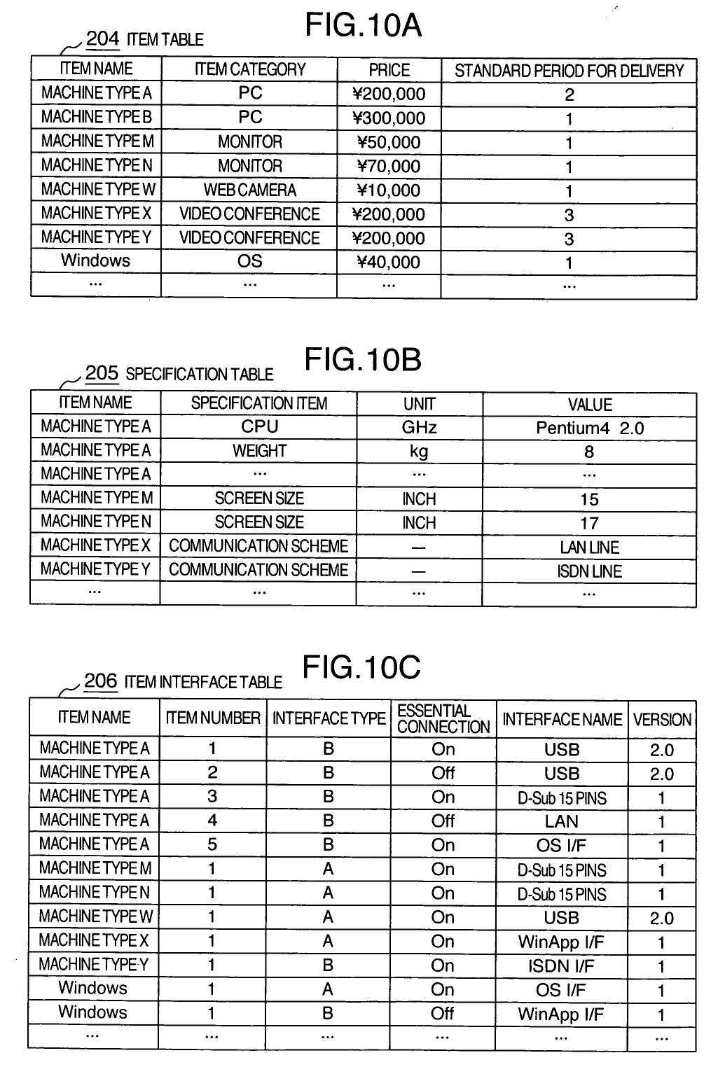

As the person in charge depresses the REGISTER button on the item registration screen, the item registration unit 11 registers entered data in the item table 205, specification table 205, and item interface table 206 shown in FIGS. 10A, 10B, 10C, respectively.

According to this embodiment, even if the number of items is increased, the specifications, possessed interface(s) and the like of a new item can be set, and the specifications, possessed interface(s) and the like of existing items can be updated while utilizing the existing application/function table 201, specification item table 202, interface table 203, item table 204, specification table 205, and item interface table 206, thus facilitating the maintenance.

The item table 204 is a table for storing the item name, item category, price, and standard period for delivery as entered on the screen in each record. A record can be uniquely identified only by the item name field. The specification table 205 is a table for storing data entered in the “specification list” on the item registration screen, and stores the item name, specification item, its value, and the unit of the specification item in each record. A record can be uniquely identified by the item name and specification item fields. The item interface table 206 is a table for storing data entered in the “possessed interface list” and stores those items including the item name, item number, interface type, essential connection, interface name, and version in each record. A record can be uniquely identified by the item name and item number fields. Each time the person in charge enters an item name in FIG. 8, the item registration unit 11 searches the item interface table 206 for records registered therein using the item name as a key, and displays retrieved records in the “possessed interface list” on the item registration screen.

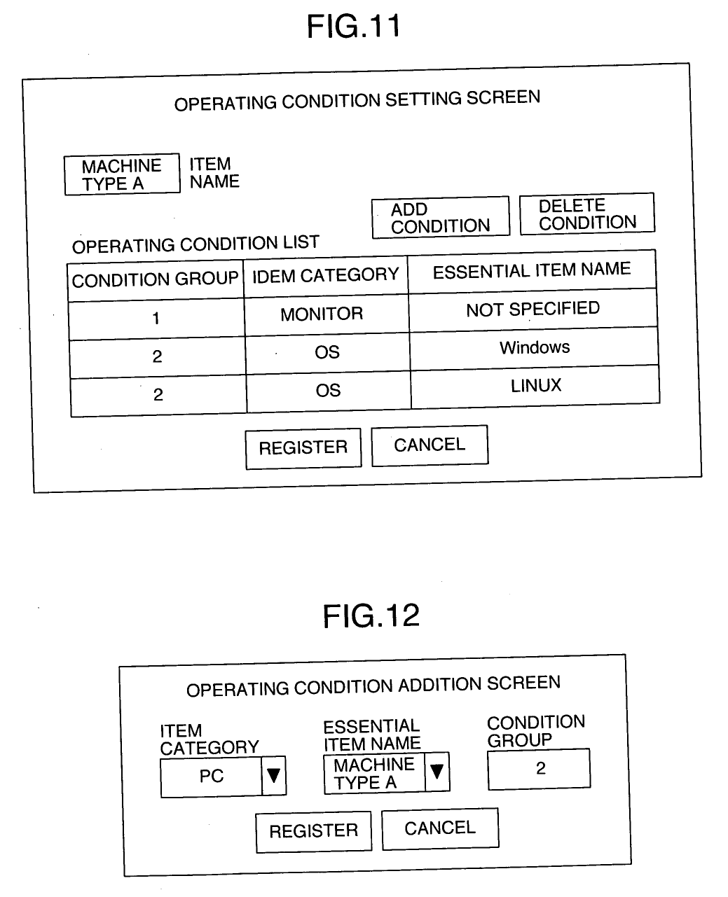

Next, a description will be given of a procedure for setting prerequisites under which an item operates. An operating condition can be added to an item as the person in charge depresses a SET OPERATING CONDITION button on the item registration screen. FIG. 11 is a diagram illustrating an example of an operating condition setting screen which is displayed when the person in charge depresses the SET OPERATING CONDITION button. The item registration unit 11 extracts records which have the same value of the item name on the screen as the item name filed on an operating condition table 207, later described, and displays the extracted records in an “operating condition list” on this screen. In an initial state, each field in the operation condition table 207 is blank. Items displayed in the “operating condition list” is comprised of a condition group, an item category, and an essential item name. The operating condition is such that an associated item cannot operate unless all item names displayed in the essential item name are available. However, if there are a plurality of essential item names which have the same “condition group,” the item can operate if any one is available. Also, if the essential item name is “not specified,” this indicates that an item can operate if even one of items which have the same item category is available. For example, in the example of the operating condition screen illustrated in FIG. 11, the prerequisite for operating a machine type A is to provide a monitor (any item name may be accepted) and OS (one of Windows or LINUX) in the item category. The operating condition is used to narrow down to items which have a particular connection relationship with the item, in addition to an interface for connecting the item to another item.

An operating condition can be added as the person in charge depresses an ADD CONDITION button. The item registration unit 11 displays an operating condition addition screen illustrated in FIG. 12 in response to a depression on the ADD CONDITION button. The item registration unit 11 puts together the columns of the item category in the specification item table 202 into one menu having item category options, which is displayed as an item category menu. The item registration unit 11 also displays the values of item name fields corresponding to records which have an item category field in the item table 204 which matches with the item category menu, as options for “essential item names.” The item registration unit 11 also displays a character string “not specified” as an additional option.

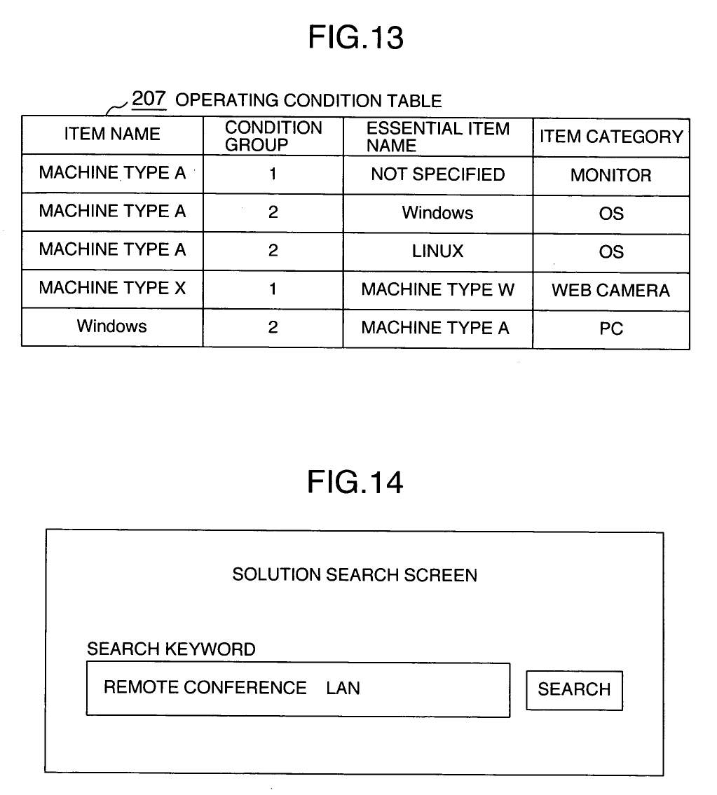

When the person in charge selects an item category and an essential item name from the respective menus on the operating condition setting screen, enters a condition group, and depresses a REGISTER button, the item registration unit 11 responsively adds the entered data to the “operating condition list.” The item registration unit 11 also registers the entered data in the operating condition table 207 shown in FIG. 13. Each record in the operating condition table 207 stores the following items: item name, condition group, essential item name, and item category. It should be noted that a record can be uniquely identified by the fields of the item name, condition group, essential item name, and item category.

Next, a description will be given of a processing procedure for searching for items required for a solution, and determining the composition for the solution, as illustrated in FIG. 3(B).

FIG. 14 is a diagram illustrating an example of a solution search screen displayed by the solution composition search unit 13. The person in charge enters a necessary search keyword in a field labeled “search key word” on this screen in accordance with a problem to be solved or a solution to be realized. Here, the search key word should be selected from key words included in “application/function” in the application/function table 201, key words extracted from plain texts, data in the specification item field and value field in the specification table 205. A plurality of search keywords can be specified by delimiting each search keyword with a space. In response to a SEARCH button depressed by the person in charge, the solution composition search unit 13 executes a solution search process.

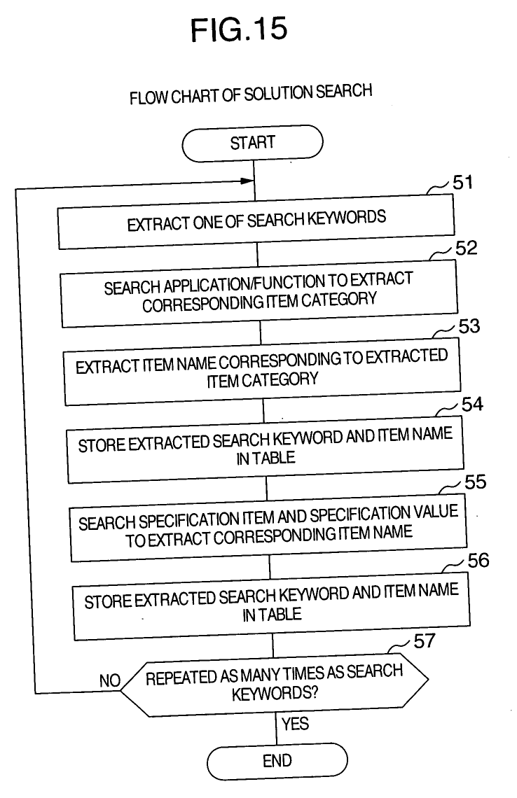

FIG. 15 is a flow chart illustrating the solution search process. First, the solution composition search unit 13 extracts one search keyword (step 51). Next, the solution composition search unit 13 searches for records which include a search keyword extracted from the application/function field in the application/function table 201 to extract a corresponding item category (step 52). Subsequently, the solution composition search unit 13 searches for records which have the same item category as that extracted from the item category field in the item table 204 to extract a corresponding item name (step 53). Next, the solution composition search unit 13 stores the extracted search keyword and item name in a search result storage table 208, later described (step 54). Next, the solution composition search unit 13 searches for records including the search keyword from the specification item field and value field in the specification table 205 to extract a corresponding item name (step 55), and stores the extracted search keyword and item name in the search result storage table 208 (step 56). Next, the solution composition search unit 13 determines whether or not the process has been repeated as many times as the number of search keywords (step 57). If there are more search keyword(s) left unprocessed, the solution composition search unit 13 returns to step 51 to repeat the foregoing process for the next keyword.

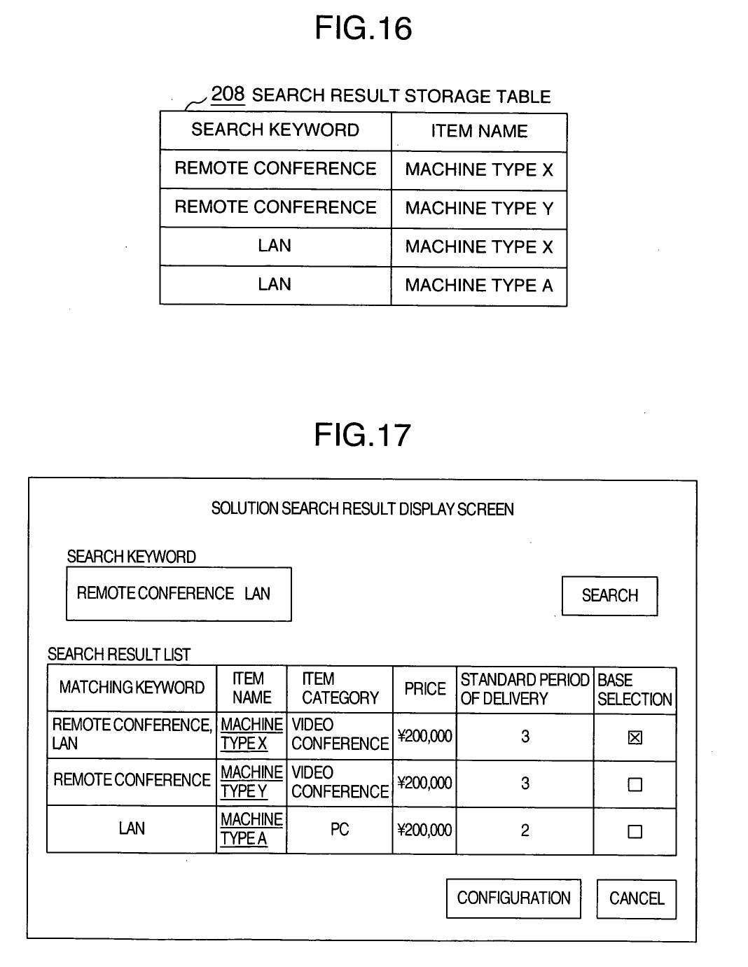

FIG. 16 is a diagram showing a data structure of the search result storage table 208 which stores a search keyword and an item name corresponding thereto. It should be noted that a record can be uniquely identified by the search keyword and item name fields.

FIG. 17 is a diagram illustrating an example of a solution search result display screen displayed by the solution composition search unit 13 when the solution search process is completed. The solution composition search unit 13 displays a “search keyword” utilized for a search, and a “search result list.” The “search result list” includes the following items: item name, item category, price, and standard period for delivery, as well as a matching keyword indicative of a search keyword which is included in these items.

The solution composition search unit 13 complies the search result storage table 208 by the item name field to acquire a corresponding search keyword for each item name. The solution composition search unit 13 also extracts matching records for each of the extracted items from the item name table 204 to acquire the item category, price, and standard period for delivery.

For building a solution utilizing items displayed on the solution search result display screen, associated items which can be required can be searched for by selecting a column “base selection” of a row selected by the person in charge, and depressing the CONFIGURATION button. Also, when a desired item has not been found, a search can be made again by changing a search keyword, and depressing the SEARCH button. Since the solution composition search unit 13 displays the item registration screen illustrated in FIG. 8 in response to an item name clicked by the person in charge, the person in charge can be given detailed information such as specifications of an item concerned to select an appropriate item name.

Alternatively, a list of item categories and item names may be displayed to prompt the person in charge to select any item category and item name from the list. In this event, instead of the process illustrated in FIG. 15, each of the item category and item name in the item table 204 may only be put together for display.

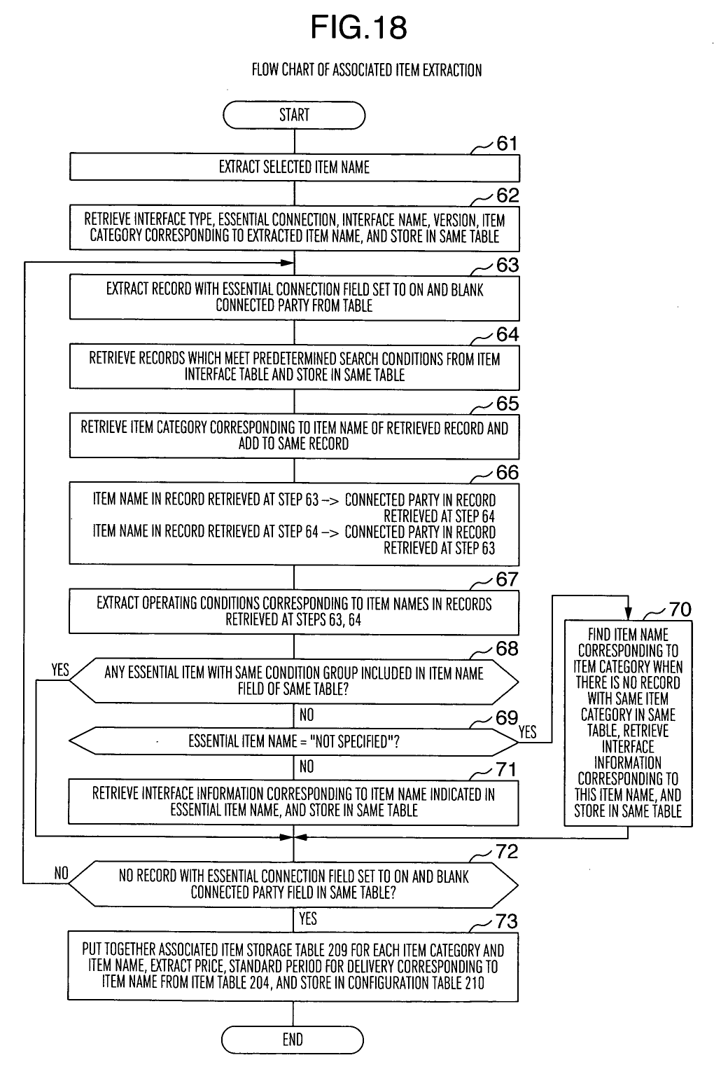

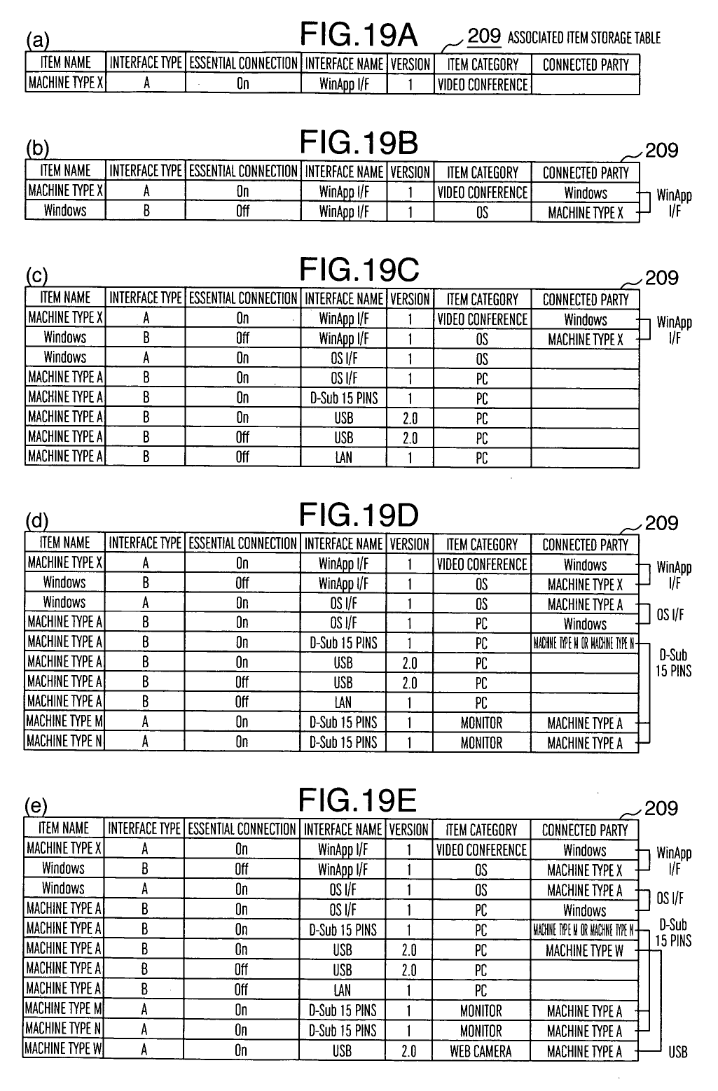

Next, a processing procedure of the solution composition search unit 13 after the person in charge has depressed the CONFIGURATION button will be described with reference to FIGS. 18 and 19A-19E. FIG. 18 is a flow chart illustrating a processing procedure executed by the configuration composition search unit 13 for extracting associated items.

FIGS. 19A to 19E each show an associated item storage table 209 which stores data resulting from the process for extracting associated items, as the process advances, in time series (a-e). Each record in the table includes the following items: item name, interface type, essential connection, interface name, version, item category, and connected party.

In the processing procedure illustrated in FIG. 18, the solution composition search unit 13 first extracts an item name for which the column “base selection” has been selected on the solution search result display screen (step 61). Next, the solution composition search unit 13 stores the interface type, essential connection, interface name, version, and item category corresponding to the extracted item name in the associated item storage table 209 (step 62). Specifically, the solution composition search unit 13 searches the item name field in the item interface table 206 using the extracted item name as a key, and stores the item name, interface type essential connection, interface name, and version of each matching record in the associated item storage table 209. Next, the solution composition search unit 13 searches the item table 204 using the extracted item name as a key to extract an item category corresponding to the item name, and stores the item category in correspondence to the item name in the associated item storage table 209. An associated item storage table 209(a) in FIG. 19A shows an example of data stored in the associated item storage table 209 when the processing at step 62 has been completed.

Subsequently, the solution composition search unit 13 extracts a record in the associated item storage table which has the item “essential connection” set to On and a blank “connected party” (step 63). Next, the solution composition search unit 13 confirms the interface name, interface type and version of the extracted record, searches the item interface 206 with the following search conditions to retrieve an appropriate record, and stores the retrieved record in the associated item storage table 209 if it is not a repeated record (step 64). The search conditions include (1) the same interface name, (2) a different interface type, and (3) the same version or lower. Next, the solution composition search unit 13 searches the item table 204 using the extracted item name as a key to extract an item category corresponding to the item name, and adds the item category to a record retrieved and stored in the associated item storage table 209 at step 64 (step 65). Next, the solution composition search unit 13 stores the item name of the record extracted at step 63 in the connected party field of the record stored at step 64, and stores the item name of the record stored at step 64 in the connected party field of the record extracted at step 63 (step 66). An associated item storage table 209(b) in FIG. 19B shows an example of data stored in the associated item storage table 209 when the processing at step 66 has been completed. Here, a record (machine type X, Windows Application Interface) and record (Windows (registered trade mark) Windows Application Interface) form a group with the same interface name.

In this example, the solution composition search unit 13 extracts Windows (OS) having an interface corresponding to the interface name “Windows Application Interface” of machine type X (video conference).

Next, the solution composition search unit 13 searches the operating condition table 207 using the item name of the record extracted at step 63 or 64 as a key to extract all records which have the same item name field (step 67). Next, the solution composition search unit 13 determines whether or not any of “essential item names” in records having the same “condition group” out of the extracted records is included in the item name field in the associated item storage table 209 (step 68). If included, the procedure goes to step 72. If not included, the solution composition search unit 13 determines whether or not the “essential item name” of that record is “not specified” (step 69).

When the “essential item name” is “not specified,” the solution composition search unit 13 determines at step 70 whether or not the associated item storage table 209 contains a record which has an item category that matches the “item category” in the record extracted at step 67. When the associated item storage table 209 contains such a record, the procedure proceeds to step 72. When the associated item storage table 209 does not contain a record which has the matching “item category,” the solution composition search unit 13 searches the item table 204 using the “item category” as a key, and stores interface information added with an item category which falls under a retrieved item name, interface type, essential connection, interface name, and version in the associated item storage table 209 (step 70).

When the “essential item name” is not “not specified,” the solution composition search unit 13 searches the item name fields of the item interface 206 using the “essential item name” of the record extracted at step 67 as a key to retrieve a matching record, adds the appropriate “item category” of the record extracted at step 67 to interface information of the retrieved record, i.e., its item name, interface type, essential connection, interface name, and version, and stores the resulting information in the associated item storage table 209 (step 71). An associated item storage table 209(c) in FIG. 19C shows an example of data stored in the associated item storage table 209 when the processing at step 71 has been completed. However, the third record (Windows, OSI/F) does not yet exist.

Next, the solution composition search unit 13 determines whether or not any record remains in the associated item storage table 209 with “essential connection” set to On, and blank “connected party” (step 72). If there is any remaining record, the solution composition search unit 13 returns to step 63 to repeat the foregoing process for the remaining record.

In the examples shown in FIGS. 19A-19E, when the processing at step 63 is repeated, the fourth record (machine type A, OSI/F) is extracted from the associated item storage table 209. The third record (Windows, OSI/F) is added to the associated item storage table 209 when the processing at the next steps 64, 65 has been completed, resulting in data stored as shown in the associated item storage table 209(c) in FIG. 19C. When the processing at the next step 66 has been completed, “machine type A” is stored in the “connected party” of the third record (Windows, OSI/F), and “Windows” is stored in the “connected party” of the fourth record (machine type A, OSI/F). At step 67, since the operating condition corresponding to the “machine type A” is “not specified,” a machine type M and a machine type N are fetched as items corresponding to the item category “monitor” at step 70, and interface information of these items is stored in the associated item storage table 209.

When the processing at step 63 is repeated the third time, the fifth record (machine type A, D-Sub 15 pins) is extracted from the associated item storage table 209. Since records retrieved by the processing at the next steps 64, 65 are the ninth record (machine type M, D-Sub 15 pins) and the tenth record (machine type N, D-Sub 15 pins), these records have already been registered in the associated item storage table 209. When the processing at the next step 66 has been completed, “machine type M or machine type N” is stored in the “connected party” of the fifth record (machine type A, D-sub 15 pins), and “machine type A” is stored in the “connected party” of each of the ninth record (machine type M, D-sub 15 pins) and tenth record (machine type N, D-sub 15 pins), resulting in the data stored as shown in an associated item table 209(d) in FIG. 19D. While an operating condition corresponding to “machine type A” is extracted at step 67, the procedure goes to a determination at step 72 from the determination at step 68 because the processing at steps 70, 71 has been completed for “machine type A.”

When the processing at step 63 is repeated the fourth time, the sixth record (machine type A, USB) is extracted from the associated item storage table 209. The eleventh record (machine type W, USB) is retrieved by the processing at the next steps 64, 65, and added to the associated item storage table 209. When the processing at the next step 66 has been completed, “machine type A” is stored in the “connected party” of the eleventh record (machine type W, USB), and “machine type W” is stored in the “connected party” of the sixth record (machine type A, USB), resulting in the data stored as shown in an associated item storage table 209(e) in FIG. 19E.

When there is no longer a record which has the “essential connection” set to On and a blank “connected party” on the associated item storage table 209 (Yes at step 72), the solution composition search unit 13 puts together the data in the associated item storage table 209 for each item category and each item, and extracts the price and standard period for delivery for each item name from the item table 204 for storage in a configuration table 210.

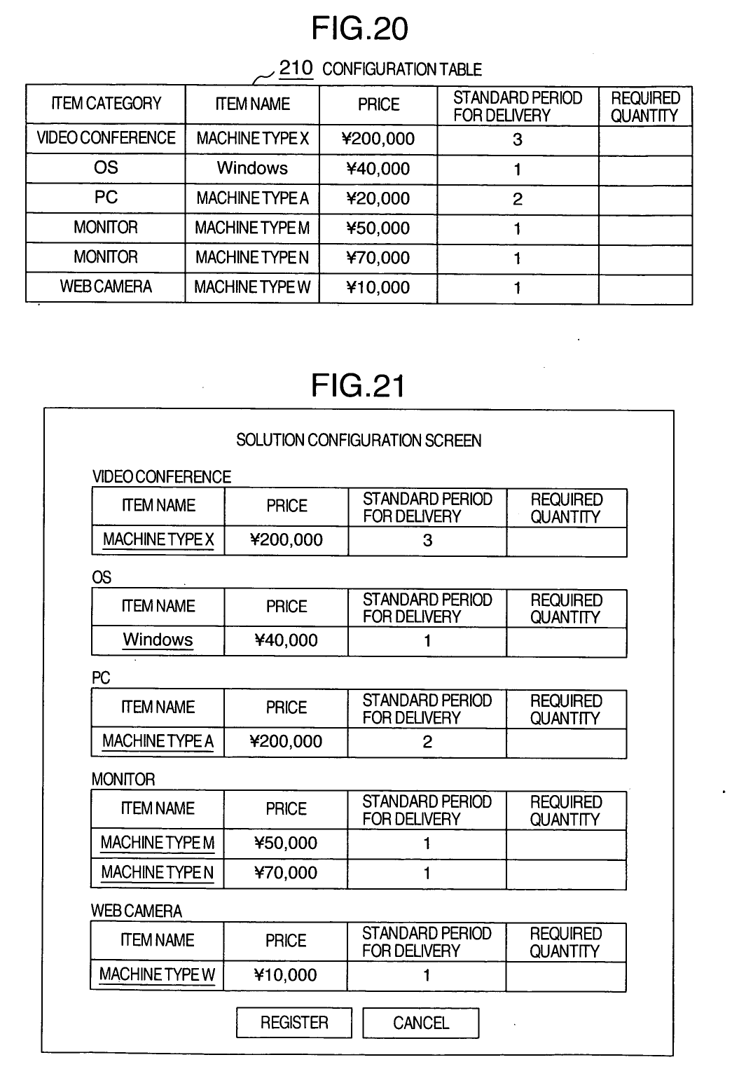

FIG. 20 is a diagram showing the data structure of the configuration table 210. Each record consists of the following items: item category, item name, price, standard period for delivery, and required quantity. It should be noted that a record can be uniquely identified by the item name field.

Finally, a description will be given of the solution composition determination unit 14 which determines a composition for a solution from the searched data. FIG. 21 is a table illustrating an example of a solution configuration screen displayed by the solution composition determination unit 14. The solution composition determination unit 14 displays for each item category a corresponding item name, price, and standard period for delivery based on the data in the configuration table 21. The person in charge enters the required quantity on this screen, and depresses a REGISTER button to establish a composition for a solution. The solution composition determination unit 14 stores the established data in the “required quantity” field in the configuration table 210. As the person in charge clicks on the item name on this screen, the solution composition determination unit 14 displays the item registration screen illustrated in FIG. 8, thus allowing the person in charge to determine the required quantity while confirming detailed information such as the specifications of the item name.

It should be further understood by those skilled in the art that although the foregoing description has been made on embodiments of the invention, the invention is not limited thereto and various changes and modifications may be made without departing from the spirit of the invention and the scope of the appended claims.

1. A configuration system for solution business comprising:
an item interface table for storing interface information in correspondence to an item name of an item, said interface information including an interface name for identifying an interface, an interface type indicative of a combination type of the interface, a version of the interface, and a flag indicating whether or not the interface is essential to the item, where the item refers to either an article, or a product, or a part of hardware and software, and the interface collectively refers to either an item intervening between a hardware item and a software item for coupling the hardware item to the software item for operation, or a combination for coupling a hardware item to a software item for operation, or communication specifications between a software item and a hardware item;
an operating condition table for storing an essential item name indicative of one of other items which is essential for operating the item in correspondence to the item name as an operating condition;
an associated item storage table for storing the interface information of an item associated with a specified item through the interface and the operating condition;
a first processing unit responsive to a specified item name for searching the item interface table to retrieve the interface information corresponding to the specified item name, and storing the retrieved interface information in said associated item storage table;
a second processing unit for extracting a piece of interface information which has the flag indicative of essential from the retrieved interface information;
a third processing unit for searching the interface information retrieved from said item interface table for interface information which has the same interface name, a different interface type, and a version equivalent or lower, and storing the interface information in said associated item storage table;
a fourth processing unit for forming a group having the same interface name of the interface information retrieved by said first processing unit and the interface information retrieved by said third processing unit;
a fifth processing unit for searching said operating condition table for the essential item name corresponding to an item name belonging to the group;
a sixth processing unit for searching said item interface table for the retrieved item name having an item name not belonging to the group, and storing interface information corresponding to the essential item name in said associated item storage table; and
a seventh processing unit for controlling said second to sixth processing units to operate when said associated item storage table includes interface information which has the flag indicative of essential and which does not belong to any of the groups.

2. A configuration system for solution business according to claim 1, wherein:
said operating condition table further includes a record for specifying an item category to which the item belongs, without specifying the essential item name, in correspondence to the item name, and
said sixth processing unit retrieves the interface information corresponding to each of items belonging to the specified item category when the essential item name is not specified, and stores the interface information in said associated item storage table.

3. A configuration system for solution business according to claim 1, further comprising a processing unit for putting together the item names stored in said created associated item storage table, adding additional specifications for items to create a configuration table, and displaying the configuration table.

4. A configuration system for solution business according to claim 3, further comprising a processing unit for receiving a quantity entered for an item required for the configuration table.

5. A configuration system for solution business according to claim 1, wherein said configuration system further holds information available as keywords for a search in correspondence to the item name, and searches the information based on the specified keyword to display candidates of item names which can be specified.

6. A configuration composition method for solution business for a computer which has an item interface table for storing interface information in correspondence to an item name of an item, said interface information including an interface name for identifying an interface, an interface type indicative of a combination type of the interface, a version of the interface, and a flag indicating whether or not the interface is essential to the item, where the item refers to either an article, or a product, or a part of hardware and software, and the interface collectively refers to either an item intervening between a hardware item and a software item for coupling the hardware item to the software item for operation, or a combination for coupling a hardware item to a software item for operation, or communication specifications between a software item and a hardware item, and an operating condition table for storing an essential item name indicative of one of other items which is essential for operating the item in correspondence to the item name as an operating condition, said method comprising:
a first step of searching the item interface table, when an item name is specified, to retrieve the interface information corresponding to the specified item name, and storing the retrieved interface information in an associated item storage table for storing the interface information of an item associated with a specified item through the interface and the operating condition;
a second step of extracting a piece of interface information which has the flag indicative of essential from the retrieved interface information;
a third step of searching the interface information retrieved from said item interface table for interface information which has the same interface name, a different interface type, and a version equivalent or lower, and storing the interface information in said associated item storage table;
a fourth step of forming a group having the same interface name of the interface information retrieved at said first step and the interface information retrieved at said third step;
a fifth step of searching said operating condition table for the essential item name corresponding to an item name belonging to the group;
a sixth step of searching said item interface table for the retrieved item name having an item name not belonging to the group, and storing interface information corresponding to the essential item name in said associated item storage table; and
a seventh step of controlling to execute said second to sixth steps when said associated item storage table includes interface information which has the flag indicative of essential and which does not belong to any of the groups.

7. A configuration composition method for solution business according to claim 6, wherein said operating condition table further includes a record for specifying an item category to which the item belongs, without specifying the essential item name, in correspondence to the item name, and
said sixth step includes retrieving the interface information corresponding to each of items belonging to the specified item category when the essential item name is not specified, and storing the interface information in said associated item storage table.

8. A configuration composition method for solution business according to claim 6, further comprising a processing step of putting together the item names stored in said created associated item storage table, adding specifications for items to create a configuration table, and displaying the configuration table.

9. A configuration composition method for solution business according to claim 8, further comprising a processing step of receiving a quantity entered for an item required for the configuration table.
